(19) United States
(12) Patent Application Publication
(10) Pub. No.: US 2007/0106516 A1
(43) Pub. Date: May 10, 2007

(54) Creating alternative audio via closed caption data

(75) Inventors: David Anthony Larson, Rochester, MN (US); Bryan Mark Logan, Rochester, MN (US); Terrence Theodore Nixa, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 11/272,586

(22) Filed: Nov. 10, 2005

(51) Int. Cl. G10L 21/00

(52) U.S. Cl. 704/270

(57) ABSTRACT

A method, apparatus, system, and signal-bearing medium that, in an embodiment, create an alternative audio file with alternative audio segments and embed markers in the alternative audio file. Each of the markers is associated with a respective alternative audio segment, and the markers identify original closed caption data segments in a program. The alternative audio file is sent to a client. The client receives the program from a content provider, matches the markers to the original closed caption data segments, and substitutes the alternative audio segments for the original audio segments via the matches during presentation of the program. In an embodiment, alternative closed caption data is created that includes alternative closed caption data segments. Markers are embedded in the alternative closed caption data, each of the markers is associated with a respective one of the alternative closed caption data segments, and the markers identify the original closed caption data segments in the program. The alternative closed caption data is sent to the client. The client matches the markers to the original closed caption data segments and substitutes the alternative closed caption data segments for the original closed caption data segments via the matches in presentation of the program. In an embodiment, alternative content is created that includes alternative audio and video segments. Markers are embedded in the alternative content, each of the markers is associated with a respective one of the alternative audio and video segments, and the markers identify the original closed caption data segments in the program. The alternative content is sent to the client. The client matches the markers to the original closed caption data segments and substitutes the alternative audio and video segments for the original closed caption data segments via the matches in presentation of the program.

### FIELD

An embodiment of the invention generally relates to digital video recorders. In particular, an embodiment of the invention generally relates to alternative audio for a program presented via a digital video recorder.

### BACKGROUND

Television is certainly one of the most influential forces of our time. Through the device called a television set or TV, viewers are able to receive news, sports, entertainment, information, and commercials. Television is a medium that is best enjoyed by both watching and listening. But, if the viewers do not understand the language that is being spoken or the text that is displayed on the screen, they are unable to fully enjoy the show or learn about the products advertised. The current methods of dealing with viewers who understand alternative languages are the following three options: providing a channel or channels dedicated to the alternative languages; providing alternative audio via a secondary audio program (SAP); or providing closed captioning (CC) in the alternative languages.

The disadvantage of dedicated channels is that the viewer is limited to a few channels of programming. Also one channel of the broadcast spectrum is allocated for the alternative language, and because of the large number of potential languages needed, the content provider (e.g., a cable or satellite company) must provide an equally large number of dedicated channels. This disadvantage also affects the SAP and CC in that they also have finite bandwidth with which to provide alternative languages. Also, SAP audio is typically provided by the producer of the content, and providing alternative audio is burdensome for content producers.

Thus, there is a need for a better technique for providing alternative language audio and closed captioning text associated with the video content.

### SUMMARY

A method, apparatus, system, and signal-bearing medium are provided that, in an embodiment, create an alternative audio file with alternative audio segments and embed markers in the alternative audio file. Each of the markers is associated with a respective alternative audio segment, and the markers identify original closed caption data segments in a program. The alternative audio file is sent to a client. The client receives the program from a content provider, matches the markers to the original closed caption data segments, and substitutes the alternative audio segments for the original audio segments via the matches during presentation of the program.

In an embodiment, alternative closed caption data is created that includes alternative closed caption data segments. Markers are embedded in the alternative closed caption data, each of the markers is associated with a respective one of the alternative closed caption data segments, and the markers identify the original closed caption data segments in the program. The alternative closed caption data is sent to the client. The client matches the markers to the original closed caption data segments and substitutes the alternative closed caption data segments for the original closed caption data segments via the matches in presentation of the program.

In an embodiment, alternative content is created that includes alternative audio and video segments. Markers are embedded in the alternative content, each of the markers is associated with a respective one of the alternative audio and video segments, and the markers identify the original closed caption data segments in the program. The alternative content is sent to the client. The client matches the markers to the original closed caption data segments and substitutes the alternative audio and video segments for the original closed caption data segments via the matches in presentation of the program.

### BRIEF DESCRIPTION OF THE DRAWING

FIG. 1 depicts a block diagram of an example digital video recorder for implementing an embodiment of the invention.

FIG. 2 depicts a block diagram of an example computer system for implementing an embodiment of the invention.

FIG. 3 depicts a block diagram of example language data, according to an embodiment of the invention.

FIG. 4 depicts a block diagram of example language preferences, according to an embodiment of the invention.

FIG. 5A depicts a block diagram of an example program, according to an embodiment of the invention.

FIG. 5B depicts a block diagram of a conceptual view of an example program, alternative audio, and alternative closed caption data, according to an embodiment of the invention.

FIG. 5C depicts a block diagram of a conceptual view of an example program and alternative content, according to an embodiment of the invention.

FIG. 6 depicts a flowchart of example processing, according to an embodiment of the invention.

FIG. 7 depicts a flowchart of example processing for a translation service, according to an embodiment of the invention.

### DETAILED DESCRIPTION

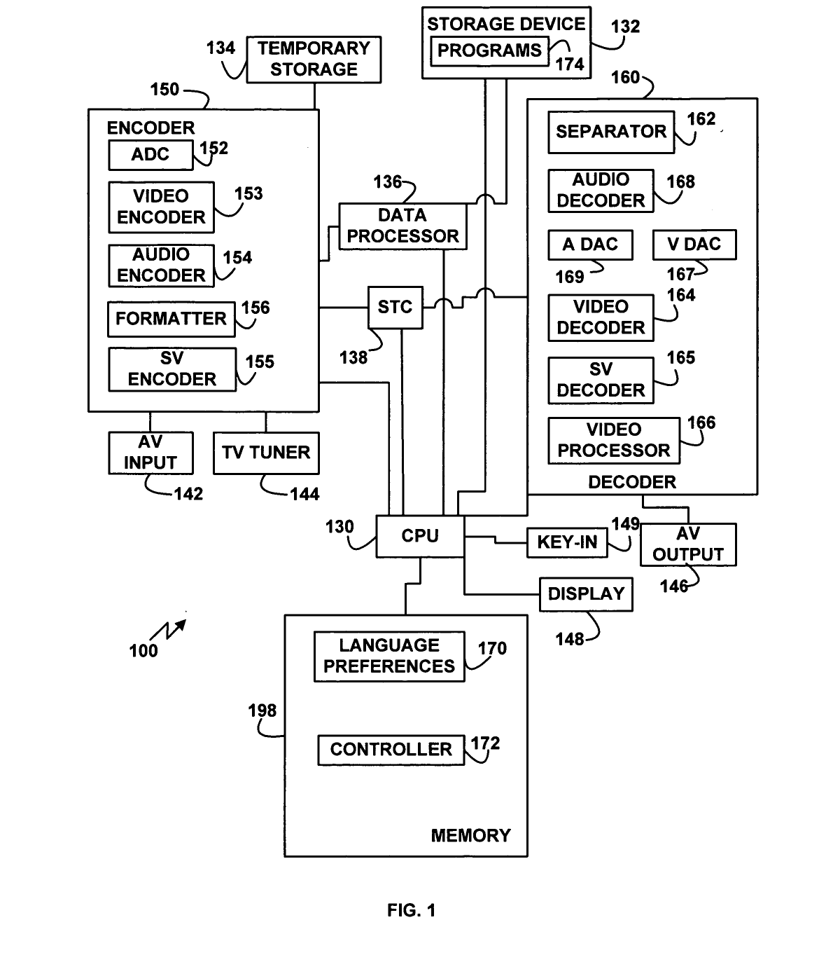

Referring to the Drawings, wherein like numbers denote like parts throughout the several views, FIG. 1 depicts a block diagram of an example digital video recorder (DVR) 100 used for recording/playing back digital moving image and/or audio information, according to an embodiment of the invention. The digital video recorder 100 includes a CPU (central processing unit) 130, a storage device 132, temporary storage 134, a data processor 136, a system time counter 138, an audio/video input 142, a TV tuner 144, an audio/video output 146, a display 148, a key-in 149, an encoder 150, a decoder 160, and memory 198. The CPU 130 may be implemented via a programmable general purpose central processing unit that controls operation of the digital video recorder 100.

The storage device 132 may be implemented by a direct access storage device (DASD), a DVD-RAM, a CD-RW, or any other type of storage device capable of encoding, reading, and writing data. The storage device 132 stores the programs 174. The programs 174 are data that are capable of being stored, retrieved, and presented. In various embodiments, the programs 174 may be television programs, radio programs, movies, video, audio, still images, graphics, or any combination thereof. In an embodiment, the program 174 includes original closed caption data.

The encoder section 150 includes an analog-digital converter 152, a video encoder 153, an audio encoder 154, a sub-video encoder 155, and a formatter 156. The analog-digital converter 152 is supplied with an external analog video signal and an external analog audio signal from the audio-video input 142 or an analog TV signal and an analog voice or audio signal from the TV tuner 144. The analog-digital converter 152 converts an input analog video signal into a digital form. That is, the analog-digital converter 152 quantitizes into digital form a luminance component Y, color difference component Cr (or Y-R), and color difference component Cb (or Y-B). Further, the analog-digital converter 152 converts an input analog audio signal into a digital form.

When an analog video signal and digital audio signal are input to the analog-digital converter 152, the analog-digital converter 152 passes the digital audio signal therethrough as it is. At this time, a process for reducing the jitter attached to the digital signal or a process for changing the sampling rate or quantization bit number may be effected without changing the contents of the digital audio signal. Further, when a digital video signal and digital audio signal are input to the analog-digital converter 152, the analog-digital converter 152 passes the digital video signal and digital audio signal therethrough as they are. The jitter reducing process or sampling rate changing process may be effected without changing the contents of the digital signals.

The digital video signal component from the analog-digital converter 152 is supplied to the formatter 156 via the video encoder 153. The digital audio signal component from the analog-digital converter 152 is supplied to the formatter 156 via the audio encoder 154.

The video encoder 153 converts the input digital video signal into a compressed digital signal at a variable bit rate. For example, the video encoder 153 may implement the MPEG2 or MPEG1 specification, but in other embodiments any appropriate specification may be used.

The audio encoder 154 converts the input digital audio signal into a digital signal (or digital signal of linear PCM (Pulse Code Modulation)) compressed at a fixed bit rate based, e.g., on the MPEG audio or AC-3 specification, but in other embodiments any appropriate specification may be used.

When a video signal is input from the audio-video input 142 or when the video signal is received from the TV tuner 144, the sub-video signal component in the video signal is input to the sub-video encoder 155. The sub-video data input to the sub-video encoder 155 is converted into a preset signal configuration and then supplied to the formatter 156. The formatter 156 performs preset signal processing for the input video signal, audio signal, sub-video signal and outputs record data to the data processor 136.

The temporary storage section 134 buffers a preset amount of data among data (data output from the encoder 150) written into the storage device 132 or buffers a preset amount of data among data (data input to the decoder section 160) played back from the storage device 132. The data processor 136 supplies record data from the encoder section 150 to the storage device 132, extracts a playback signal played back from the storage device 132, rewrites management information recorded on the storage device 132, or deletes data recorded on the storage device 132 according to the control of the CPU 130.

The contents to be notified to the user of the digital video recorder 100 are displayed on the display 148 or are displayed on a TV or monitor (not shown) attached to the audio-video output 146.

The timings at which the CPU 130 controls the storage device 132, data processor 136, encoder 150, and/or decoder 160 are set based on time data from the system time counter 138. The recording/playback operation is normally effected in synchronism with the time clock from the system time counter 138, and other processes may be effected at a timing independent from the system time counter 138.

The decoder 160 includes a separator 162 for separating and extracting each pack from the playback data, a video decoder 164 for decoding main video data separated by the separator 162, a sub-video decoder 165 for decoding sub-video data separated by the separator 162, an audio decoder 168 for decoding audio data separated by the separator 162, and a video processor 166 for combining the sub-video data from the sub-video decoder 165 with the video data from the video decoder 164.

The video digital-analog converter 167 converts a digital video output from the video processor 166 to an analog video signal. The audio digital-analog converter 169 converts a digital audio output from the audio decoder 168 to an analog audio signal. The analog video signal from the video digital-analog converter 167 and the analog audio signal from the audio digital-analog converter 169 are supplied to external components (not shown), which are typically a television set, monitor, or projector, via the audio-video output 146.

Next, the recording process and playback process of the digital video recorder 100 are explained, according to an embodiment of the invention. At the time of data processing for recording, if the user first effects the key-in operation via the key-in 149, the CPU 130 receives a recording instruction for a program and reads out management data from the storage device 132 to determine an area in which video data is recorded. In another embodiment, the CPU 130 determines the program to be recorded.

Then, the CPU 130 sets the determined area in a management area and sets the recording start address of video data on the storage device 132. In this case, the management area specifies the file management section for managing the files, and control information and parameters necessary for the file management section are sequentially recorded.

Next, the CPU 130 resets the time of the system time counter 138. In this example, the system time counter 138 is a timer of the system and the recording/playback operation is effected with the time thereof used as a reference.

The flow of a video signal is as follows. An audio-video signal input from the audio-video input 142 or the TV tuner 144 is A/D converted by the analog-digital converter 152, and the video signal and audio signal are respectively supplied to the video encoder 153 and audio encoder 154, and the closed caption signal from the TV tuner 144 or the text signal of text broadcasting is supplied to the sub-video encoder 155.

The encoders 153, 154, 155 compress the respective input signals to make packets, and the packets are input to the formatter 156. In this case, the encoders 153, 154, 155 determine and record PTS (presentation time stamp), DTS (decode time stamp) of each packet according to the value of the system time counter 138. The formatter 156 sets each input packet data into packs, mixes the packs, and supplies the result of mixing to the data processor 136. The data processor 136 sends the pack data to the storage device 132, which stores it as one of the programs 174.

At the time of playback operation, the user first effects a key-in operation via the key-in 149, and the CPU 130 receives a playback instruction therefrom. Next, the CPU 130 supplies a read instruction and address of the program 174 to be played back to the storage device 132. The storage device 132 reads out sector data according to the supplied instruction and outputs the data in a pack data form to the decoder section 160.

In the decoder section 160, the separator 162 receives the readout pack data, forms the data into a packet form, transfers the video packet data (e.g., MPEG video data) to the video decoder 164, transfers the audio packet data to the audio decoder 168, and transfers the sub-video packet data to the sub-video decoder 165.

After this, the decoders 164, 165, 168 effect the playback processes in synchronism with the values of the PTS of the respective packet data items (output packet data decoded at the timing at which the values of the PTS and system time counter 138 coincide with each other) and supply a moving picture with voice caption to the TV, monitor, or projector (not shown) via the audio-video output 146.

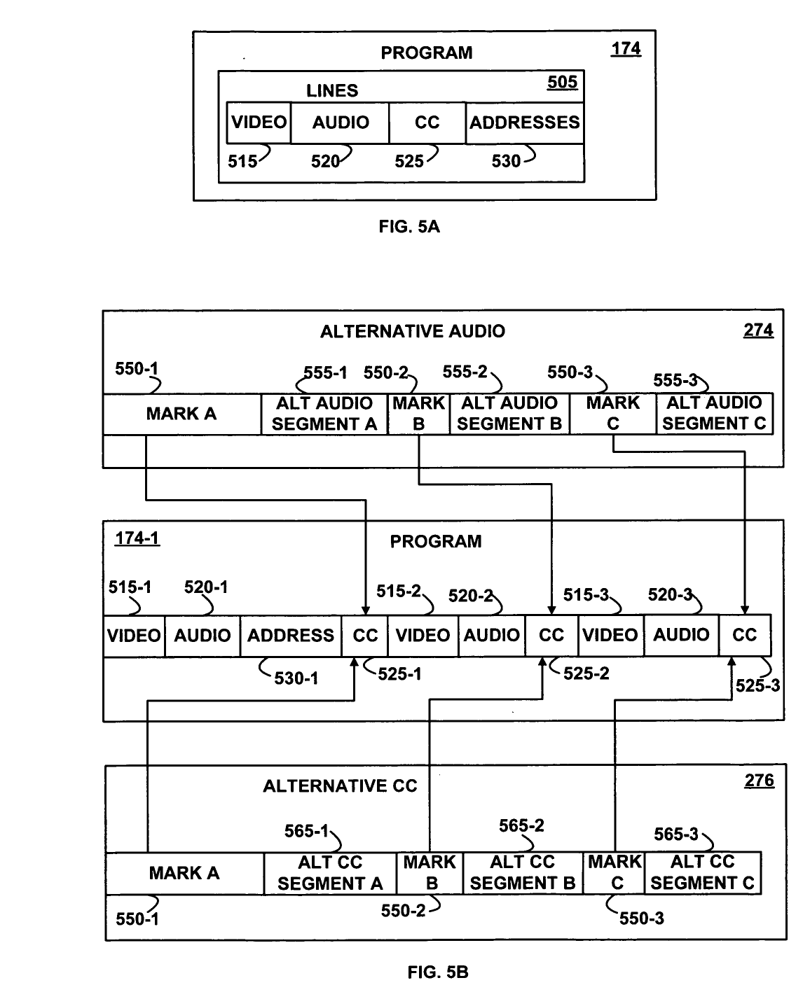

The memory 198 is connected to the CPU 130 and includes the language preferences 170 and the controller 172. The language preferences 170 describe the way in which portions of the program 174 were viewed. In another embodiment, the language preferences 170 are embedded in or stored with the programs 174. The language preferences 170 are further described below with reference to FIG. 4.

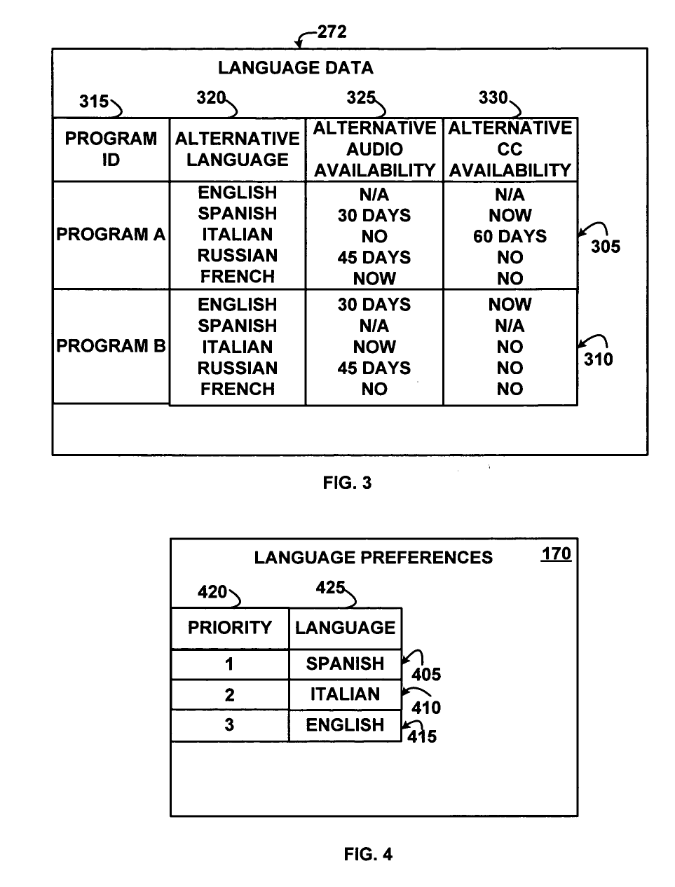

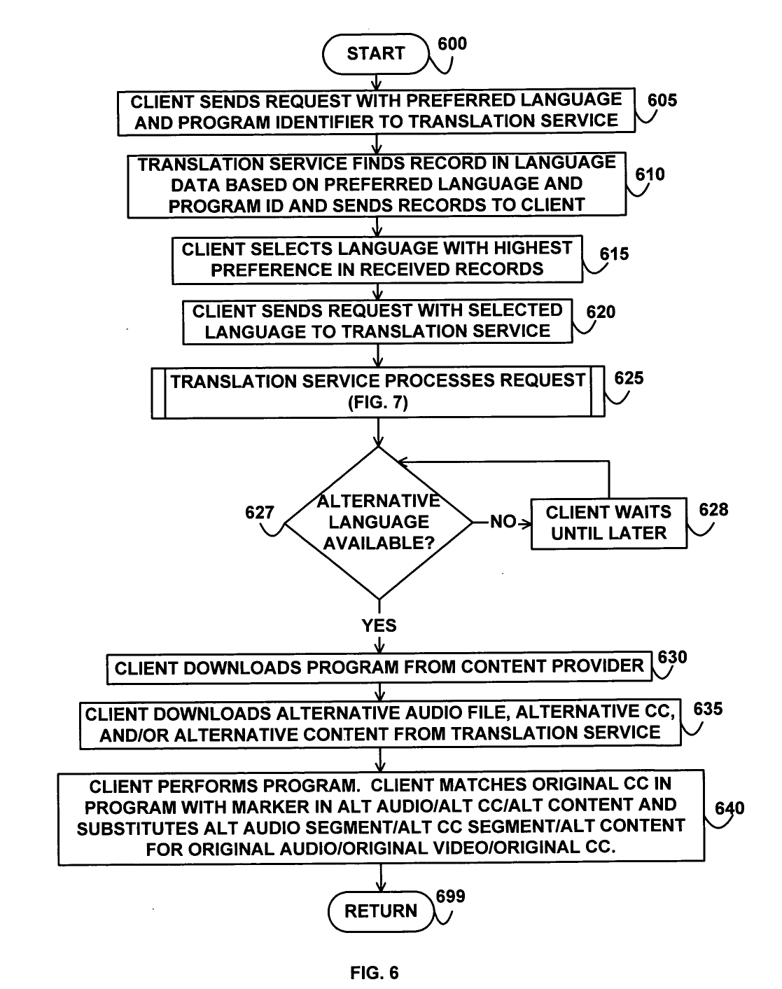

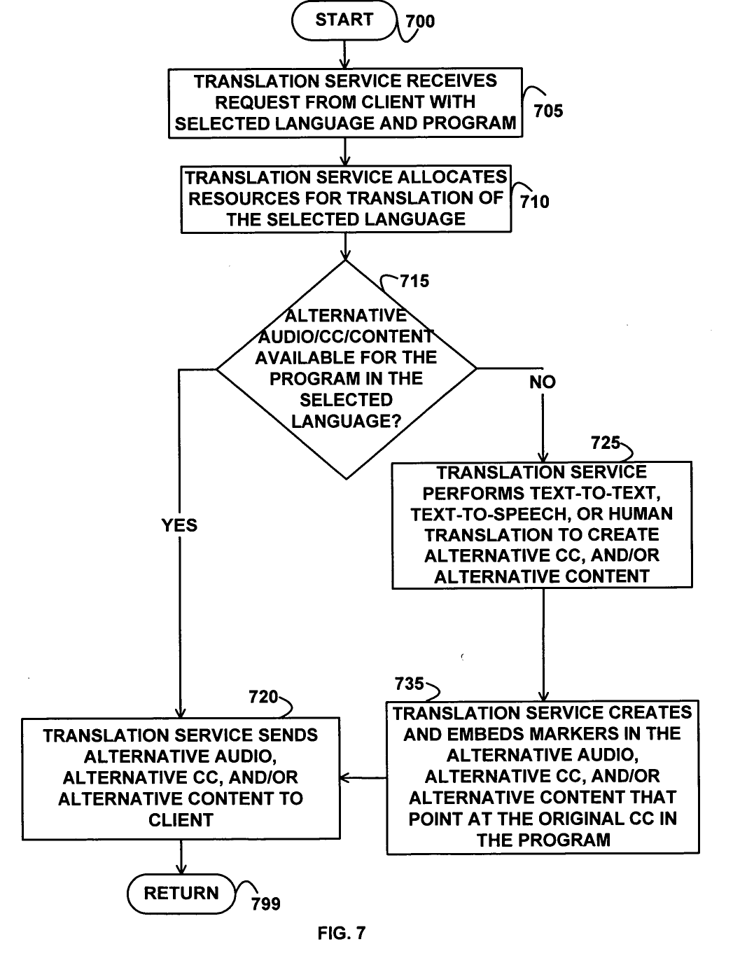

The controller 172 includes instructions capable of executing on the CPU 130 or statements capable of being interpreted by instructions executing on the CPU 130 to manipulate the language preferences 170 and the programs 174, as further described below with reference to FIGS. 3, 4, 5A, 5B, and 5C and to perform the functions as further described below with reference to FIGS. 6 and 7. In another embodiment, the controller 172 may be implemented in microcode. In another embodiment, the controller 172 may be implemented in hardware via logic gates and/or other appropriate hardware techniques in lieu of, or in addition to, a processor-based digital video recorder.

In other embodiments, the digital video recorder 100 may be implemented as a personal computer, mainframe computer, portable computer, laptop or notebook computer, PDA (Personal Digital Assistant), tablet computer, pocket computer, television, set-top box, cable decoder box, telephone, pager, automobile, teleconferencing system, camcorder, radio, audio recorder, audio player, stereo system, MP3 (MPEG Audio Layer 3) player, digital camera, appliance, or any other appropriate type of electronic device.

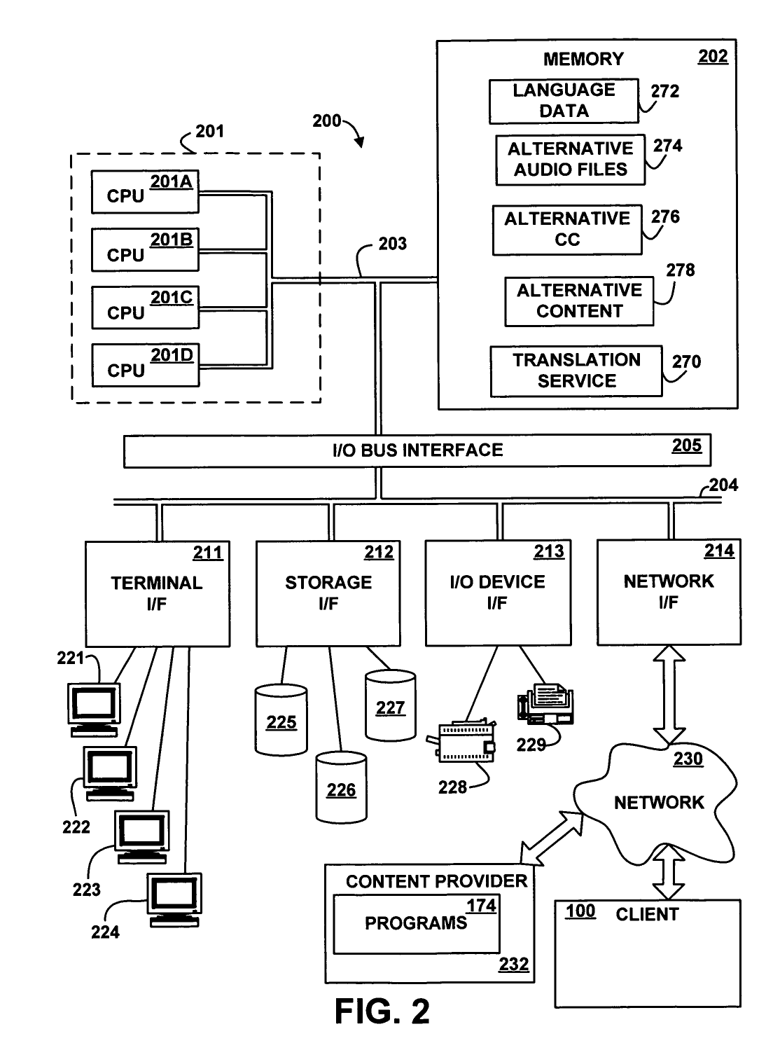

FIG. 2 depicts a high-level block diagram representation of a server computer system 200 connected to the client digital video recorder 100 via a network 230, and a content provider 232 connected to the client 100 via the network 230, according to an embodiment of the present invention. The words “client” and “server” are used for convenience only, and in other embodiments an electronic device that operates as a client in one scenario may operate as a server in another scenario, or vice versa. The major components of the computer system 200 include one or more processors 201, a main memory 202, a terminal interface 211, a storage interface 212, an I/O (Input/Output) device interface 213, and communications/network interfaces 214, all of which are coupled for inter-component communication via a memory bus 203, an I/O bus 204, and an I/O bus interface unit 205.

The computer system 200 contains one or more general-purpose programmable central processing units (CPUs) 201A, 201B, 201C, and 201D, herein generically referred to as the processor 201. In an embodiment, the computer system 200 contains multiple processors typical of a relatively large system; however, in another embodiment the computer system 200 may alternatively be a single CPU system. Each processor 201 executes instructions stored in the main memory 202 and may include one or more levels of on-board cache.

The main memory 202 is a random-access semiconductor memory for storing data and computer programs. The main memory 202 is conceptually a single monolithic entity, but in other embodiments the main memory 202 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 202 includes a translation service 270, language data 272, alternative audio files 274, alternative closed caption data 276, and alternative content 278. Although the translation service 270, the language data 272, the alternative audio files 274, the alternative closed caption data 276, and alternative content 278 are illustrated as being contained within the memory 202 in the computer system 200, in other embodiments some or all may be on different computer systems and may be accessed remotely, e.g., via the network 230. The computer system 200 may use virtual addressing mechanisms that allow the software of the computer system 200 to behave as if it only has access to a large, single storage entity instead of access to multiple, smaller storage entities. Thus, while the translation service 270, the language data 272, the alternative audio files 274, the alternative closed caption data 276, and alternative content 278 are illustrated as residing in the memory 202, these elements are not necessarily all completely contained in the same storage device at the same time.

In an embodiment, the translation service 270 includes instructions capable of executing on the processors 201 or statements capable of being interpreted by instructions executing on the processors 201 to manipulate the language data 272, the alternative audio files 274, the alternative closed caption data 276, and the alternative content 278 as further described below with reference to FIGS. 6 and 7. In another embodiment, the translation service 270 may be implemented in microcode. In another embodiment, the translation service 270 may be implemented in hardware via logic gates and/or other appropriate hardware techniques in lieu of, or in addition to, a processor-based system. The alternative audio files 274, the alternative closed caption data 276, and the alternative content 278 are alternative in the sense that they are not embedded in, or a portion of, the programs 174 and are distinguished from (and may be in a different language than) any original audio or original closed caption data that might be embedded in, or a portion of, the programs 174.

The memory bus 203 provides a data communication path for transferring data among the processors 201, the main memory 202, and the I/O bus interface unit 205. The I/O bus interface unit 205 is further coupled to the system I/O bus 204 for transferring data to and from the various I/O units. The I/O bus interface unit 205 communicates with multiple I/O interface units 211, 212, 213, and 214, which are also known as I/O processors (IOPs) or I/O adapters (IOAs), through the system I/O bus 204. The system I/O bus 204 may be, e.g., an industry standard PCI (Peripheral Component Interconnect) bus, or any other appropriate bus technology. The I/O interface units support communication with a variety of storage and I/O devices. For example, the terminal interface unit 211 supports the attachment of one or more user terminals 221, 222, 223, and 224.

Although the memory bus 203 is shown in FIG. 2 as a relatively simple, single bus structure providing a direct communication path among the processors 201, the main memory 202, and the I/O bus interface 205, in another embodiment the memory bus 203 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 205 and the I/O bus 204 are shown as single respective units, in other embodiments the computer system 200 may contain multiple I/O bus interface units 205 and/or multiple I/O buses 204. While multiple I/O interface units are shown, which separate the system I/O bus 204 from various communications paths running to the various I/O devices, in other embodiments some or all of the I/O devices are connected directly to one or more system I/O buses.

The storage interface unit 212 supports the attachment of one or more direct access storage devices (DASD) 225, 226, and 227, which are typically rotating magnetic disk drive storage devices, although they could alternatively be other devices, including arrays of disk drives configured to appear as a single large storage device to a host. The I/O and other device interface 213 provides an interface to any of various other input/output devices or devices of other types. Two such devices, the printer 228 and the fax machine 229, are shown in the exemplary embodiment of FIG. 2, but in other embodiment many other such devices may exist, which may be of differing types. The network interface 214 provides one or more communications paths from the computer system 200 to other digital electronic devices and computer systems; such paths may include, e.g., one or more networks 230.

The network 230 may be any suitable network or combination of networks and may support any appropriate protocol suitable for communication of data, programs, and/or code to/from the computer system 200, the content provider 232, and/or the client 100. In an embodiment, the network 230 may represent a television network, whether cable, satellite, or broadcast TV, either analog or digital. In an embodiment, the network 230 may represent a storage device or a combination of storage devices, either connected directly or indirectly to the computer system 200. In an embodiment, the network 230 may support Infiniband. In another embodiment, the network 230 may support wireless communications. In another embodiment, the network 230 may support hard-wired communications, such as a telephone line or cable. In another embodiment, the network 230 may support the Ethernet IEEE (Institute of Electrical and Electronics Engineers) 802.3× specification. In another embodiment, the network 230 may be the Internet and may support IP (Internet Protocol). In another embodiment, the network 230 may be a local area network (LAN) or a wide area network (WAN). In another embodiment, the network 230 may be a hotspot service provider network. In another embodiment, the network 230 may be an intranet. In another embodiment, the network 230 may be a GPRS (General Packet Radio Service) network. In another embodiment, the network 230 may be a FRS (Family Radio Service) network. In another embodiment, the network 230 may be any appropriate cellular data network or cell-based radio network technology. In another embodiment, the network 230 may be an IEEE 802.11 B wireless network. In still another embodiment, the network 230 may be any suitable network or combination of networks. Although one network 230 is shown, in other embodiments any number of networks (of the same or different types) may be present.

The computer system 200 depicted in FIG. 2 has multiple attached terminals 221, 222, 223, and 224, such as might be typical of a multi-user “mainframe” computer system. Typically, in such a case the actual number of attached devices is greater than those shown in FIG. 2, although the present invention is not limited to systems of any particular size. The computer system 200 may alternatively be a single-user system, typically containing only a single user display and keyboard input, or might be a server or similar device that has little or no direct user interface, but receives requests from other computer systems (clients). In other embodiments, the computer system 200 may be implemented as a personal computer, portable computer, laptop or notebook computer, PDA (Personal Digital Assistant), tablet computer, pocket computer, telephone, pager, automobile, teleconferencing system, video recorder, camcorder, audio recorder, audio player, stereo system, MP3 (MPEG Audio Layer 3) player, digital camera, appliance, or any other appropriate type of electronic device.

The content provider 232 includes programs 174, which the client 100 may download. In various embodiments, the content provider 232 may be a television station, a cable television system, a satellite television system, an Internet television provider or any other appropriate content provider. Although the content provider 232 is illustrated as being separate from the computer system 200, in another embodiment they may be packaged together.

It should be understood that FIGS. 1 and 2 are intended to depict the representative major components of the client 100, the computer system 200, the content provider 232, and the network 230 at a high level, that individual components may have greater complexity than that represented in FIGS. 1 and 2, that components other than, instead of, or in addition to those shown in FIGS. 1 and 2 may be present, and that the number, type, and configuration of such components may vary. Several particular examples of such additional complexity or additional variations are disclosed herein; it being understood that these are by way of example only and are not necessarily the only such variations.

The various software components illustrated in FIGS. 1 and 2 and implementing various embodiments of the invention may be implemented in a number of manners, including using various computer software applications, routines, components, programs, objects, modules, data structures, etc., referred to hereinafter as “computer programs.” The computer programs typically comprise one or more instructions that are resident at various times in various memory and storage devices in the client 100 and the computer system 200, and that, when read and executed by one or more processors 130 or 136 in the client 100 and/or the processor 201 in the computer system 200, cause the client 100 and/or the computer system 200 to perform the steps necessary to execute steps or elements embodying the various aspects of an embodiment of the invention.

Moreover, while embodiments of the invention have and hereinafter will be described in the context of fully functioning computer systems and digital video recorders, the various embodiments of the invention are capable of being distributed as a program product in a variety of forms, and the invention applies equally regardless of the particular type of signal-bearing medium used to actually carry out the distribution. The programs defining the functions of this embodiment may be delivered to the client digital video recorder 100 and/or the computer system 200 via a variety of tangible signal-bearing computer-recordable media, which include, but are not limited to:

(1) information permanently stored on a non-rewriteable storage medium, e.g., a read-only memory device attached to or within a computer system, such as CD-ROM, DVD−R, or DVD+R;

(2) alterable information stored on a rewriteable storage medium, e.g., a hard disk drive (e.g., DASD 225, 226, or 227, the storage device 132, or the memory 198), a CD-RW, CD-RW, DVD-RW, DVD+RW, DVD-RAM, or diskette;

(3) information conveyed to the digital video recorder 100 or the computer system 200 by a communications medium, such as through a computer or a telephone network, e.g., the network 230, including wireless communications.

Such tangible signal-bearing computer-recordable media, when carrying machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIGS. 1 and 2 are not intended to limit the present invention. Indeed, other alternative hardware and/or software environments may be used without departing from the scope of the invention.

FIG. 3 depicts a block diagram of example language data 272, according to an embodiment of the invention. The language data 272 includes records 305 and 310, but in other embodiments any number of records with any appropriate data may be present. Each of the records 305 and 310 includes a program identifier field 315, an alternative language field 320, an alternative-audio availability field 325, and an alternative-closed-caption availability field 330, but in other embodiments more or fewer fields may be present.

The program identifier field 315 identifies one of the programs 174. The alternative language 320 identifies a list of possible alternative languages that might be available for the associated program 174. The alternative audio availability field 325 indicates whether each of the alternative languages 320 is currently available in alternative audio form, and if not currently available, the expected availability date of the alternative audio (if an expected availability date exists), in either absolute or relative terms. The alternative audio availability 325 may also indicate that the associated language is not applicable because the original audio for the program is already in that language (e.g. English is indicated as not applicable for program A in record 305 and Spanish is indicated as not applicable for program B in record 310 because these programs have those languages for their original audio). The alternative-closed-caption availability field 330 indicates whether each of the alternative languages 320 is currently available in closed-caption form, and if not currently available, the expected availability date, either in absolute or relative form.

FIG. 4 depicts a block diagram of example language preferences 170, according to an embodiment of the invention. The language preferences 170 include records 405, 410, and 415, but in other embodiments any number of records with any appropriate data may be present. Each of the records 405, 410, and 415 includes a priority field 420 and a language field 425, but in other embodiments more or fewer fields may be present. The priority field 420 identifies the priority, ranking, or preference order of the user for the associated alternative languages 425. The language field 425 indicates one of the alternative languages 320.

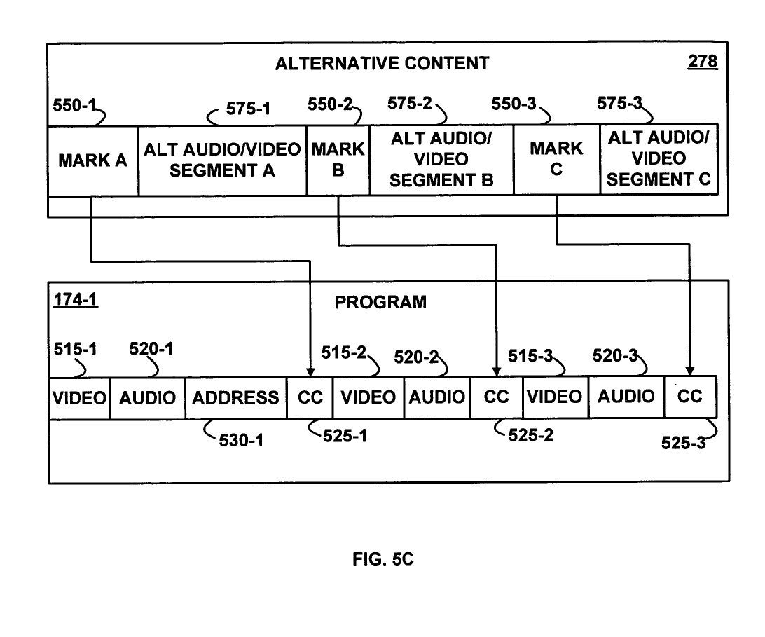

FIG. 5A depicts a block diagram of an example program 174, according to an embodiment of the invention. The example program 174 includes lines 505. The lines 505 may be implemented in the NTSC (National Television System Committee) standard, or any other appropriate standard or format. Examples of various standards and formats include: PAL (Phase Alternate Line), SECAM (Sequential Color and Memory), RS 170, RS 330, HDTV (High Definition Television), MPEG (Motion Picture Experts Group), DVI (Digital Video Interface), SDI (Serial Digital Interface), AIFF, AU, CD, MP3, QuickTime, RealAudio, WAV, and PCM (Pulse Code Modulation). The lines 505 may represent any content within the program 174, such as video 515, original audio 520, original closed caption data 525, original addresses 530, or any portion thereof. The video 515 may include a succession of still images, which when presented or displayed give the impression of motion. The audio 520 includes sounds.

The original closed caption data 525 is optional and may include a text representation of the audio 520 and is typically presented as a text video overlay that is optional or not normally visible unless requested, as opposed to open captions, which are a permanent part of the video and always displayed. Closed captions are typically a textual representation of the spoken audio and sound effects. Most television sets are designed to allow the optional display of the closed caption data near the bottom of the screen. A television set may also use a decoder or set-top box to display the closed captions. Closed captions are typically used so that the programs 174 may be understood by hearing impaired viewers, may be understand by viewers in a noisy environment (e.g., an airport), or may be understand in an environment that must be kept quiet (e.g., a hospital). In an embodiment, the closed caption data is encoded within the video signal, e.g., in line 21 of the vertical blanking interval (VBI), but in other embodiments, any appropriate encoding technique may be used.

The original addresses 530 includes the address or location of content external to the program 174, such as an address of a web site accessed via the network 230 that contains content associated with the lines 505.

FIG. 5B depicts a block diagram of a conceptual view of a program 174-1, which is an example of the program 174, according to an embodiment of the invention. The example program 174-1 includes video 515-1, 515-2, and 515-3, which are examples of the video 515. The example program 174-1 further includes original audio segments 520-1, 520-2, and 520-3, which are examples of the original audio 520. The example program 174-1 further includes original closed caption data segments 525-1, 525-2, and 525-3, which are examples of the original closed caption data 525. The program 174-1 further includes an original address 530-1, which is an example of the original addresses 530. The video 515-1, the original audio segment 520-1, the original closed caption data segment 525-1, and the original address 530-1 are associated, meaning they, or their associated content, may be presented simultaneously or in a synchronized manner. The video 515-2, the original audio segment 520-2, and the original closed caption data segment 525-2 are associated, meaning that they may be presented simultaneously. The video 515-3, the original audio segment 520-3, and the original closed caption data segment 525-3 are associated, meaning that they may be presented simultaneously or in a synchronized manner.

FIG. 5B further depicts a block diagram of an example data structure for the alternative audio file 274, according to an embodiment of the invention. The alternative audio file 274 includes a marker A 550-1, an alternative audio segment A 555-1, a marker B 550-2, an alternative audio segment B 555-2, a marker C 550-3, and an alternative audio segment C 555-3. The marker A 550-1 in the alternative audio file 274 is associated with the alternative audio segment A 555-1. The marker B 550-2 in the alternative audio file 274 is associated with the alternative audio segment B 555-2. The marker C 550-3 in the alternative audio file 274 is associated with the alternative audio segment C 555-3. The marker A 550-1 points at or identifies original closed caption data, such as the original closed caption data segment 525-1. The marker B 550-2 points at or identifies original closed caption data, such as the original closed caption data segment 525-2. The marker C 550-3 points at or identifies original closed caption data, such as the original closed caption data segment 525-3.

FIG. 5B further depicts a block diagram of an example data structure for alternative closed caption data 276, according to an embodiment of the invention. The closed caption data 276 includes a marker A 550-1, an alternative closed caption segment A 565-1, a marker B 550-2, an alternative closed caption segment B 565-2, a marker C 550-3, and an alternative closed caption segment C 565-3. The marker A 550-1 in the alternative closed caption data 276 is associated with the alternative closed caption segment A 565-1. The marker B 550-2 in the alternative closed caption data 276 is associated with the alternative closed caption segment B 565-2. The marker C 550-3 in the alternative closed caption data 276 is associated with the alternative closed caption segment C 565-3. The marker A 550-1 points at or identifies original closed caption data, such as the original closed caption data segment 525-1. The marker B 550-2 points at or identifies original closed caption data, such as the original closed caption data segment 525-2. The marker C 550-3 points at or identifies original closed caption data, such as the original closed caption data segment 525-3.

FIG. 5C depicts a block diagram of a conceptual view of the example program 174-1 and alternative content 278, according to an embodiment of the invention. The alternative content 278 may include, e.g., commercials tailored for a particular audience or any other appropriate information, video overlays that customize a commercial for a particular location or language (e.g., presentation of a telephone number that is local to the viewer) or any other appropriate information. Although the alternative audio 274 and the alternative closed caption data 276 are not illustrated in FIG. 5C, in various embodiments, one or both of them may be present.

The alternative content 278 includes a marker A 550-1, an alternative audio and/or video segment A 575-1, a marker B 550-2, an alternative audio and/or video segment B 575-2, a marker C 550-3, and an alternative audio and/or video segment C 575-3. The marker A 550-1 in the alternative content 278 is associated with the alternative audio/video segment A 575-1. The marker B 550-2 in the alternative content 278 is associated with the alternative audio/video segment B 575-2. The marker C 550-3 in the alternative content 278 is associated with the alternative audio/video segment C 575-3. The marker A 550-1 points at or identifies original closed caption data, such as the original closed caption data segment 525-1 in the program 174-1. The marker B 550-2 points at or identifies original closed caption data, such as the original closed caption data segment 525-2 in the program 174-1. The marker C 550-3 points at or identifies original closed caption data, such as the original closed caption data segment 525-3 in the program 174-1.

FIG. 6 depicts a flowchart of example processing, according to an embodiment of the invention. Control begins at block 600. Control then continues to block 605 where the client controller 172 sends a request with a preferred language and program identifier to the translation service 270. Control then continues to block 610 where the translation service 270 finds a record in the language data 272 based on the received preferred language order (via the language field 425 and the priority field 420) and received program identifier (via the program identifier field 315) and sends the record to the client 100. Control then continues to block 615 where the client controller 172 selects the language with the highest preference or priority in the received record or records. In an embodiment, a user may have the option to override the selection of the language that is performed by the client controller 172.

Control then continues to block 620 where the client controller 172 sends a request with a selected language to the translation service 270. Control then continues to block 625 where the translation service 270 processes the request, as further described below with reference to FIG. 7.

Control then continues to block 627 where the client controller 172 determines whether the selected language is available via the audio availability field 325 and the closed caption availability field 330.

If the determination at block 627 is false, then control continues to block 628 where the client controller 172 waits to download data for the selected language at the later date specified by the audio availability field 325 and/or the closed caption availability field 330. Control then returns to block 627, as previously described above.

In another embodiment, the processing of blocks 627 and 628 is optional, and the client controller 172 proceeds to block 630 without them, in order to allow the user to view the program 174 without the benefit of an alternative language.

If the determination at block 627 is true, then control continues to block 630 where the client controller 172 downloads the program 174, including the original closed caption data from the content provider 232 and optionally finds any original addresses 530 in the program 174 and downloads any content pointed to by the original addresses 530. Control then continues to block 635 where the client controller 172 downloads the alternative audio files 274, alternative closed caption data 276, and/or the alternative content 278 (if available) via the translation service 270 at the computer system 100.

Control then continues to block 640 where the client controller 172 performs or displays the program 174, matching the original closed caption data in the program 174 with the markers in the alternative audio 274, the alternative closed caption data 276, and/or the alternative content 278, and substitutes the alternative audio segments, the alternative closed caption data segments, and/or the alternative content segments for the original audio segment, the original video segment, or the original closed caption data based on the markers. In an embodiment where the alternative audio 274, the alternative closed caption data 276, and/or the alternative content 278 are not available, the client controller 172 performs or displays the program 174 without them. Control then continues to block 699 where the logic of FIG. 6 returns.

FIG. 7 depicts a flowchart of example processing for a translation service 270, according to an embodiment of the invention. Control begins at block 700. Control then continues to block 705 where the translation service 270 receives a request from a client 100 with a selected language and program. Control then continues to block 710 where the translation service 270 allocates resources for the translation of the selected language and program. In an embodiment, the request at block 705 is a pre-request, which allows the translation service 270 to know the future demand for resources and thus allocate the resources at block 710.

Control then continues to block 715 where the translation service 270 determines whether the alternative audio files 274, alternative closed caption data 276, and/or alternative content 278 are available for the selected language and program. If the determination at block 715 is true, then control continues to block 720 where the translation service 270 sends the alternative audio files 276, the alternative closed caption data 276, and/or the alternative content 278 to the client 100. Control then continues to block 799 where the logic of FIG. 7 returns.

If the determination at block 715 is false, then the alternative audio files 274 and/or the alternative closed caption data 276 are not available for the selected language, so control continues to block 725 where the translation service 270 creates the alternative audio files 274, the alternative closed caption data 276, and/or the alternative content 278 for the selected language via human translation, text-to-speech, or text-to-text translation. Control then continues to block 735 where the translation service 270 creates and embeds markers (e.g., the markers 550-1, 550-2, 550-3) in the alternative audio 274, the alternative closed caption data 276, and/or the alternative content 278, which point at or identify the original closed caption data 525 in the program 174. Each of the markers is associated with a respective one of the alternative audio segments, the markers identify the original closed caption data segments in the program, and each of the markers is associated with a respective alternative closed caption data segment. Control then continues to block 720, as previously described above.

In the previous detailed description of exemplary embodiments of the invention, reference was made to the accompanying drawing (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized, and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
creating an alternative audio file for a program, wherein the alternative audio file comprises a plurality of alternative audio segments; and
embedding a first plurality of markers in the alternative audio file, wherein each of the first plurality of markers is associated with a respective one of the plurality of alternative audio segments, wherein the first plurality of markers identify a plurality of original closed caption data segments in the program.

2. The method of claim 1, further comprising:
sending the alternative audio file to a client.

3. The method of claim 2, wherein the client receives the program from a content provider, matches the first plurality of markers to the original closed caption data segments, and substitutes the alternative audio segments for the original audio segments in presentation of the program via the matches.

4. The method of claim 1, further comprising:
selecting a language for the alternative audio file based on an order of language preferences received from a client.

5. The method of claim 4, further comprising:
performing the creating and the embedding in response to a request from the client.

6. The method of claim 1, further comprising:
creating alternative closed caption data comprising a plurality of alternative closed caption data segments; and
embedding a second plurality of markers in the alternative closed caption data, wherein each of the second plurality of markers is associated with a respective one of the plurality of alternative closed caption data segments, wherein the second plurality of markers identify the plurality of original closed caption data segments in the program.

7. The method of claim 6, further comprising:
sending the alternative closed caption data to a client, wherein the client synchronizes the alternative closed caption data with video from the program for presentation via the second plurality of markers.

8. A signal-bearing medium encoded with instructions, wherein the instructions when executed comprise:
creating an alternative audio file for a program, wherein the alternative audio file comprises a plurality of alternative audio segments;
embedding a first plurality of markers in the alternative audio file, wherein each of the first plurality of markers is associated with a respective one of the plurality of alternative audio segments, wherein the first plurality of markers identify a plurality of original closed caption data segments in the program; and
sending the alternative audio file to a client, wherein the client receives the program from a content provider, matches the first plurality of markers to the original closed caption data segments, and substitutes the alternative audio segments for the original audio segments in presentation of the program via the matches.

9. The signal-bearing medium of claim 8, further comprising:
selecting a language for the alternative audio file based on an order of language preferences received from a client.

10. The signal-bearing medium of claim 8, further comprising:
performing the creating and the embedding in response to a request from the client.

11. The signal-bearing medium of claim 8, further comprising:
creating alternative closed caption data comprising a plurality of alternative closed caption data segments; and
embedding a second plurality of markers in the alternative closed caption data, wherein each of the second plurality of markers is associated with a respective one of the plurality of alternative closed caption data segments, wherein the second plurality of markers identify the plurality of original closed caption data segments in the program.

12. The signal-bearing medium of claim 11, further comprising:
sending the alternative closed caption data to the client, wherein the client matches the second plurality of markers to the original closed caption data segments, and substitutes the alternative closed caption data segments for the original closed caption data segments via the matches in presentation of the program.

13. The signal-bearing medium of claim 8, further comprising:
creating alternative content comprising a plurality of alternative audio and video segments; and
embedding a second plurality of markers in the alternative content, wherein each of the second plurality of markers is associated with a respective one of the plurality of alternative audio and video segments, wherein the second plurality of markers identify the plurality of original closed caption data segments in the program.

14. The signal-bearing medium of claim 13, further comprising:
sending the alternative content to the client, wherein the client matches the second plurality of markers to the original closed caption data segments, and substitutes the alternative audio and video segments for the original closed caption data segments via the matches in presentation of the program.

15. A method for configuring a computer, comprising:
configuring the computer to select a language for an alternative audio file based on an order of language preferences received from a client;
configuring the computer to create the alternative audio file for a program, wherein the alternative audio file comprises a plurality of alternative audio segments;
configuring the computer to embed a first plurality of markers in the alternative audio file, wherein each of the first plurality of markers is associated with a respective one of the plurality of alternative audio segments, wherein the first plurality of markers identify a plurality of original closed caption data segments in the program; and
configuring the computer to send the alternative audio file to a client, wherein the client receives the program from a content provider, matches the first plurality of markers to the original closed caption data segments, and substitutes the alternative audio segments for the original audio segments in presentation of the program via the matches.

16. The method of claim 15, further comprising:
configuring the computer to perform the creating and the embedding in response to a request from the client.

17. The method of claim 15, further comprising:
configuring the computer to create alternative closed caption data comprising a plurality of alternative closed caption data segments; and
configuring the computer to embed a second plurality of markers in the alternative closed caption data, wherein each of the second plurality of markers is associated with a respective one of the plurality of alternative closed caption data segments, wherein the second plurality of markers identify the plurality of original closed caption data segments in the program.

18. The method of claim 17, further comprising:
configuring the computer to send the alternative closed caption data to the client, wherein the client matches the second plurality of markers to the original closed caption data segments, and substitutes the alternative closed caption data segments for the original closed caption data segments via the matches in presentation of the program.

19. The method of claim 15, further comprising:
configuring the computer to create alternative content comprising a plurality of alternative audio and video segments; and
configuring the computer to embed a second plurality of markers in the alternative content, wherein each of the second plurality of markers is associated with a respective one of the plurality of alternative audio and video segments, wherein the second plurality of markers identify the plurality of original closed caption data segments in the program.

20. The method of claim 19, further comprising:
configuring the computer to send the alternative content to the client, wherein the client matches the second plurality of markers to the original closed caption data segments, and substitutes the alternative audio and video segments for the original closed caption data segments via the matches in presentation of the program.
